(19) United States
(12) Patent Application Publication
(10) Pub. No.: US 2015/0049236 A1
(43) Pub. Date: Feb. 19, 2015

(54) VIEW FINDER DEVICE AND CAMERA INCLUDING THE SAME

(71) Applicant: SAMSUNG ELECTRONICS CO., LTD., Suwon-si, Gyeonggi-do (KR)

(72) Inventors: Sang-tae Kim, Suwon-si (KR); Lae-kyoung Kim, Icheon-si (KR)

(21) Appl. No.: 14/356,948

(22) PCT Filed: Nov. 8, 2012
(86) PCT No.: PCT/KR2012/009359

§ 371 Date: May 8, 2014

(30) Foreign Application Priority Data
Nov. 14, 2011 (KR) 10-2011-0118512

(51) Int. Cl. H04N 5/232; G03B 13/02

(52) U.S. Cl. CPC H04N 5/23293; H04N 5/23245; G03B 13/02
USPC 348/333.09; 348/341

(57) ABSTRACT

A view finder device includes a main body including a via hole, through which light of a subject transmits; and a transparent display formed of a transparent material that transmits the light, and disposed on an optical path of the light that has been transmitted through the via hole in order to transmit the light or to display images that overlap with the light transmitting the via hole when a signal is applied to the transparent display.

### CROSS REFERENCE TO RELATED APPLICATIONS

This application is a national stage entry of international patent application no. PCT/KR2012/009359, filed Nov. 8, 2012, which claims the benefit of Korean Patent Application No. 10-2011-0118512, filed on Nov. 14, 2011, in the Korean Intellectual Property Office, the disclosures of which are incorporated herein in their entirety by reference.

### BACKGROUND

Disclosed herein is a view finder device, and more particularly, a view finder device using a transparent display that displays images or transmits light, and a camera adopting the view finder device.

In a field of imaging apparatuses such as digital cameras or digital camcorders, efforts for reducing a size and a thickness of the imaging apparatus have been continuously made. A user of single lens reflex cameras or twin-lens reflex cameras may prefer an apparatus having a view finder, through which the user may identify an image of a subject that is to be photographed.

According to the invention disclosed in Korean Patent Document No. 2010-0114419, various optical elements such as a pentaprism, a lens, and a mirror are necessary to realize an optical view finder, and thus, a space for forming an optical path and disposing the optical elements becomes larger. Thus, there is a limitation in realizing a camera having compact design.

Disclosed herein is a view finder device and a camera, capable of providing convenient view finder functions while realizing compact design.

Also disclosed is a view finder device and a camera, capable of providing a view finder operating as both an electronic view finder and an optical view finder with a simple structure that may not use components occupying a large space.

According to an embodiment of the invention, there is provided a view finder device including: a main body including a via hole, through which light of a subject transmits; and a transparent display formed of a transparent material that transmits the light, and disposed on an optical path of the light that has been transmitted through the via hole in order to transmit the light or to display images that overlap with the light transmitting the via hole when a signal is applied to the transparent display.

The view finder device may further include a light blocking unit disposed on the optical path of the light that has been transmitted through the via hole to block the light incident into the transparent display or transmit the light to the transparent display.

The view finder device may further include at least one lens disposed on the optical path of the light that has been transmitted through the via hole.

The lens, the light blocking unit, and the transparent display may be sequentially arranged along a proceeding direction of the light that has been transmitted through the via hole.

The light blocking unit, the lens, and the transparent display may be sequentially arranged along a proceeding direction of the light that has been transmitted through the via hole.

The light blocking unit may be a liquid crystal device that transmits the light to the transparent display or blocks the light incident into the transparent display when a signal is applied to the light blocking unit.

The view finder device may further include at least one lens disposed on the optical path of the light that has been transmitted through the via hole, wherein the liquid crystal device may be fabricated as a film that is attached to a surface of the lens.

The view finder device may further include a zoom lens unit disposed on the optical path of the light transmitted through the via hole to be movable along the optical path.

The view finder device may further include an eyepiece that is disposed on a rear portion of the transparent display on the optical path of the light that has been transmitted through the via hole, and forms an image with the light.

According to another embodiment, there is provided a camera including: a main body including a via hole, through which light of a subject transmits; a transparent display formed of a transparent material that transmits the light, and disposed on an optical path of the light that has been transmitted through the via hole in order to transmit the light or to display images that overlap with the light transmitting the via hole when a signal is applied to the transparent display; a lens unit disposed apart from the via hole of the main body for receiving the light; an imaging unit disposed in the main body for converting the light transmitted through the lens unit into a signal representing an image; and a control unit disposed in the main body and electrically connected to the transparent display and the imaging unit to control the transparent display and the imaging unit.

The camera may further include a light blocking unit disposed on the optical path of the light that has been transmitted through the via hole and controlled by the control unit to block the light incident into the transparent display or transmit the light to the transparent display.

The control unit may selectively execute one of an electronic view finder mode, in which the control unit controls the light blocking unit to block the light that has been transmitted through the via hole and may control the transparent display to display images, and an optical view finder mode, in which the control unit controls the light blocking unit to transmit the light to the transparent display to display the subject to be photographed.

According to the view finder device and the camera of various embodiments, the transparent display that may transmit the light and simultaneously display images that overlap with the transmitted light is used so that the hybrid view finder that may perform as both the optical viewfinder (OVF) and the electronic view finder (EVF) may be realized. The OVF function may be executed by using a simple structure including the transparent display without using the optical elements such as a pentaprism and a mirror, and thus, a compact camera and a compact view finder may be fabricated.

In addition, the information about the photographing may be freely displayed during executing the OVF function, and thus, the function of the view finder device for helping the photographing may be increased.

In addition, the user may use the EVF function and the OVF function at the same region of the camera, and thus, the user interface of the EVF and the OVF functions may be combined, thereby increasing the user's convenience.

### DESCRIPTION OF DRAWINGS

The above and other features and advantages will become more apparent by describing in detail exemplary embodiments thereof with reference to the attached drawings in which:

FIG. 1 is a schematic block diagram of a camera according to an embodiment;

FIG. 2 is a perspective view of the camera shown in FIG. 1;

FIG. 3 is a schematic cross sectional side view showing a configuration of a view finder device included in the camera of FIG. 1;

FIG. 4 is a schematic cross sectional side view showing an operating state of the view finder device of FIG. 3;

FIG. 5 is a schematic cross sectional side view of a configuration of a view finder device according to another embodiment;

FIG. 6 is a schematic cross sectional side view of an operating state of the view finder device of FIG. 5;

FIG. 7 is a screen shot diagram showing a view finder image displayed by the view finder device of FIG. 5;

FIG. 8 is a screen shot diagram showing a view finder image displayed by the view finder device of FIG. 6; and

FIG. 9 is a schematic cross sectional side view showing a configuration of a view finder device according to another embodiment.

### DETAILED DESCRIPTION

Hereinafter, structures and operations of a view finder device according to embodiments of the invention will be described in detail with reference to accompanying drawings.

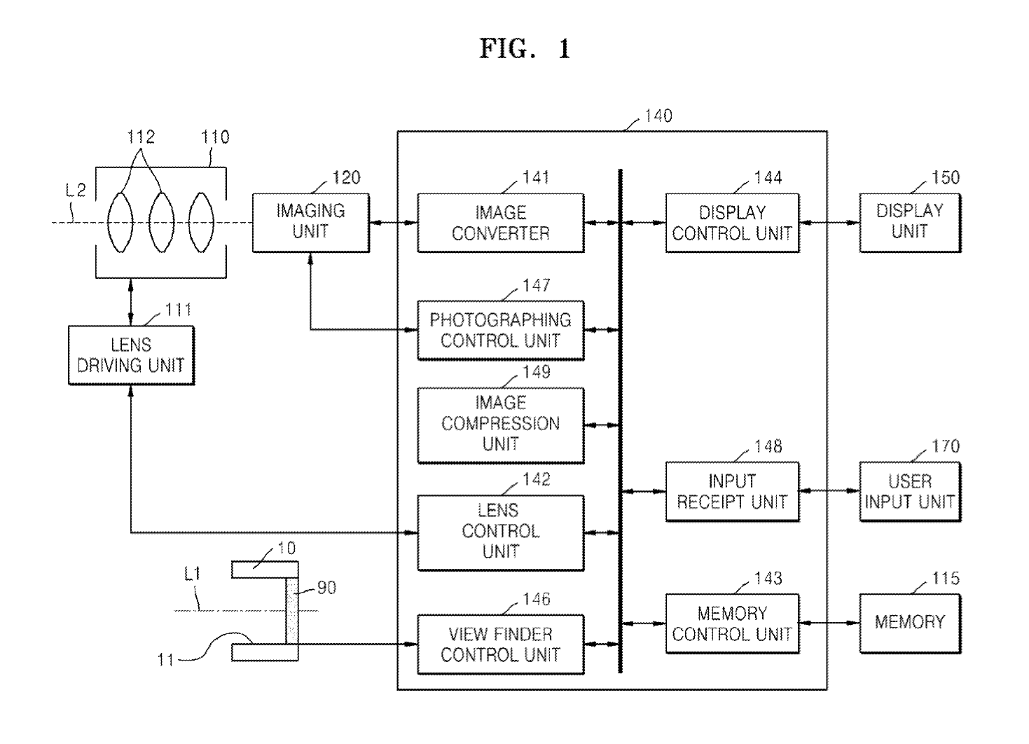

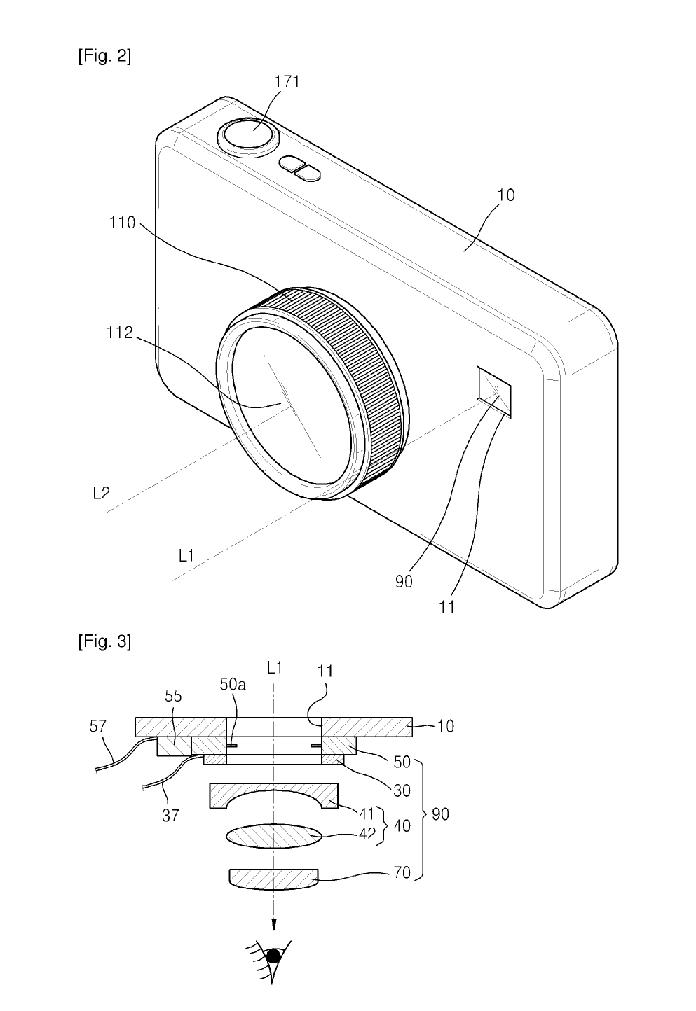

The camera shown in FIGS. 1 and 2 includes a main body 10 and a view finder device 90. FIG. 1 only shows a part of the main body 10 of FIG. 2, which includes a via hole 11, and components such as a control unit 140, etc., shown in FIG. 1 are installed in the main body 10 shown in FIGS. 2.

The camera according to the present embodiment may be a digital still camera taking still images or a digital video camera taking moving pictures.

The main body 10 surrounds various components of the camera to protect and support the components. The main body 10 includes a via hole 11, through which light from a subject transmits.

The view finder device 90 is disposed on the via hole 11 of the main body 10 to provide a user with a view finder image, by which the user may identify a frame of a subject to be photographed and photographing conditions. The view finder device 90 is disposed on a first optical path L1 of the camera to receive light incident from the subject.

Referring to FIG. 1, relations between various components mounted in the main body 10 of the camera shown in FIG. 2 are illustrated.

An imaging unit 120 photographs the subject and converts an image of the subject into an electric signal. The electric signal generated by the imaging unit 120 is converted into image data by an image conversion unit 141. A photographing control unit 147 in a control unit 140 controls the imaging unit 120 to execute the photographing operation.

A lens barrel 110 disposed in front of the imaging unit 120 includes a plurality of lenses 112 to form an optical system. An external light from a subject passes through the plurality of lenses 112 and forms images on an imaging surface of the imaging unit 120. The lens barrel 110 may be fixed onto the main body 10 of the camera, or may be detachably coupled to the main body 10 if the camera is designed as an interchangeable lens camera.

The plurality of lenses 112 are arranged such that distances between the lenses 112 may be variable. When the distances between the lenses 112 are changed, zoom magnification or focus may be adjusted. The lenses 112 are arranged along a second optical path L2 at a portion that is separated from the first optical path L1, and the second optical path L2 denotes a virtual straight line connecting optical centers of the lenses 112.

The lenses 112 are driven by a lens driving unit 111 that has a driving unit such as a zoom motor (not shown) to change locations with respect to each other. The lenses 112 may include a zoom lens for magnifying or reducing a size of the subject, and a focusing lens for focusing the subject.

The lens driving unit 111 receives a control signal from a lens control unit 142 of the control unit 140, and controls locations of the lenses 112 so that the lenses 112 may have one of a plurality of magnifications.

The imaging unit 120 includes a photoelectric conversion device such as a charge coupled device (CCD) or a complementary metal oxide semiconductor (CMOS) to convert the light of the subject incident through the lenses 112 into an electric signal. The imaging unit 120 is driven on receiving a control signal applied from the photographing control unit 147.

An image converter 141 converts the electric signal of the photographing unit 120 into image data to perform an image process or to store the image data in a storage medium such as a memory 115. For example, the image converter 141 converts the electric signal of the photographing unit 120 into red (R), green (G), and blue (B) data, and then, converts the RGB data into raw data such as a YUV signal including a brightness (Y) signal and a color difference (UV) signal.

In addition, conversion processes of the electric signal of the photographing unit 120 by the image converter 141 may include sub-processes for, e.g., reducing driving noise of the photographing unit 120 included in the electric signal by using a correlated double sampling (CDS) circuit, adjusting gain of the electric signal after the noise reduction by using an automatic gain control (AGC) circuit, converting an analog signal into a digital signal using an analog/digital (A/D) converter, correcting pixel defects, correcting gain, and gamma-correcting of the digital signal. The CDS circuit, the AGC circuit, or the A/D converter may be configured as additional circuits.

The control unit 140 is electrically connected to the photographing unit 120, the lens driving unit 111, a display unit 150, a user input unit 170, the memory 115, and the view finder device 90, and transmits control signals to the components for controlling operations of the components or processes data.

The control unit 140 includes the image converter 141, the lens control unit 142, a memory control unit 143, a display control unit 144, a view finder control unit 146, a photographing control unit 147, an input receipt unit 148, and an image compression unit 149.

The control unit 140 may be realized as a microchip, or a circuit board including a microchip. In addition, components included in the control unit 140 may be realized by software or circuits built in the control unit 140.

The memory control unit 143 controls recording of data in the memory 115, and reading of the recorded data or setting information from the memory 115.

The memory 115 may be a volatile built-in memory, for example, and may be formed of a semiconductor memory device such as synchronous dynamic random access memory (SDRAM). The memory 115 functions as a buffer memory that temporarily stores the image data generated by the image converter 141 and an operation memory used to process data.

The memory 115 may be a non-volatile external memory, for example, a flash memory such as a memory stick, a secured digital (SD)/multimedia card (MMC), a storage apparatus such as a hard disk drive (HDD), or an optical storage apparatus such as a digital versatile disc (DVD) or a compact disc (CD). In the memory 115, image data that is compressed and converted into a format such as a Joint Photographic Experts Group (JPEG) file, a tagged image file (TIF) file, a graphics interchange format (GIF) file, or a PC paintbrush (PCX) file may be stored.

The display unit 160 may be realized by a display device such as a liquid crystal display (LCD) or an organic light emitting diode (OLED). In addition, a touch panel that senses touches on a surface thereof and generates signals corresponding to sensed locations may be disposed on a surface of the display unit 150.

Referring to FIG. 2, a shutter button 171 is disposed on an edge of the camera. The shutter button 171 is an example of the user input unit 170 shown in FIG. 1.

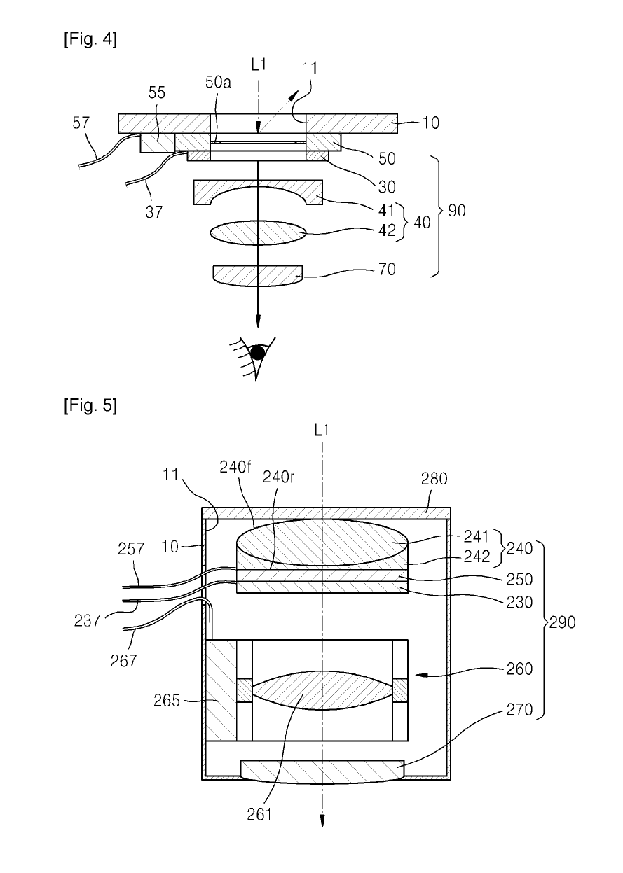

FIG. 3 is a schematic view showing a configuration of the view finder device 90 disposed on the camera of FIG. 1, and FIG. 4 is a schematic view showing operating states of the view finder device 90 of FIG. 3.

The view finder device 90 includes a transparent display 30 that is disposed on the first optical path L1 transmitting through the via hole 11 of the main body 10, a lens 40, a light blocking unit 50, and an eyepiece 70.

The transparent display 30 is formed of a transparent material that transmits light. When a signal is applied from the control unit 140 shown in FIG. 1 to the transparent display 30 through a wire 37, the transparent display 30 displays image as overlapping with transmitted light or transmits the light without displaying the image.

The transparent display is different from the conventional LCD in that a viewer may see the opposite side over the transparent display through the transparent display such as a glass window. The conventional display uses electrodes that are formed of an opaque material to form a plurality of light emitting pixels that display images, and thus, the light may not be transmitted through the display. However, the transparent display may be fabricated by using a transparent material having excellent light transmittance to form wires supplying signals to the light emitting pixels and electrodes, or fabricated by realizing characteristics like a transparent glass plate by designing locations of the wires and the light emitting pixels in consideration of visual property of human eyes.

The lens 40 focuses image light of the subject onto the eyepiece 70 to generate an image of the subject so that the user of the camera may see the image.

In FIG. 3, the view finder device 90 includes the lens 40 and the eyepiece 70; however, the embodiments of the invention are not limited thereto. That is, the lens 40 may include a first lens 41 and a second lens 42, for example, and the number of lenses may be increased or only one lens may be used. In addition, the eyepiece 70 may be omitted, or locations of the eyepiece 70 and the lens 40 may be changed.

The light blocking unit 50 may be disposed on the via hole 11. The light blocking unit 50 is operated by a signal applied thereto through the wire 57 to block or open the via hole 11. The light blocking unit 50 may be realized as a liquid crystal device or a mechanical shutter device to be automatically operated.

However, the embodiments of the invention are not limited to the above structure of the light blocking unit 50, that is, the light blocking unit 50 may be installed to be operated manually. For example, the light blocking unit 50 may be formed by installing a blocking plate that manually moves between a location of blocking the via hole 11 and a location of opening the via hole 11 on the main body 10 of the camera.

In the embodiment shown in FIGS. 3 and 4, the light blocking unit 50 includes a mechanical shutter 50a that is operated by a driving unit 55. In FIG. 3, the mechanical shutter 50a is opened so that the light may be transmitted through the via hole 11, and in FIG. 4, the mechanical shutter 50a is closed to block the light not to transmit through the via hole 11.

As shown in FIG. 3, the light transmitting through the via hole 11 sequentially transmits through the transparent display 30, the lens 40, and the eyepiece 70. The image of the subject may be provided to the user who observes the subject via the view finder device 90 through the eyepiece 70. The above function may be referred to as an optical view finder (OVF) function.

During execution of the OVF function, the transparent display 30 may display information for the photographing. The information for the photographing may include a composition frame for helping the user observe the subject and compose the frame, numbers or signs denoting exposure, text information for adjusting tone, information representing still image photographing or moving picture photographing, information representing connection status, a mark denoting a recognized face when the face of a person is recognized, a mark denoting a focal area corresponding to an object that is automatically focused, and a mark representing directions in relation to geography of the space where the photographing is performed.

The transparent display 30 may display the information for the photographing as overlapping with the image light of the subject during performing the OVF function. Therefore, the user using the OVF function may identify various information relating to the photographing, and at the same time, may adjust the composition of the subject while observing the image of the subject.

As shown in FIG. 4, in a state where the light transmitted through the via hole 11 is blocked, a darkroom-like environment is generated, that is, there is no external light transmitting through the transparent display 30, the lens 40, and the eyepiece 70. In the state where the darkroom-like environment is provided, the view finder control unit 146 may transfer a live view image acquired by the imaging unit 120 to the view finder device 90. As described above, a function of electrically displaying the image of the subject is referred to as an electronic view finder (EVF) function.

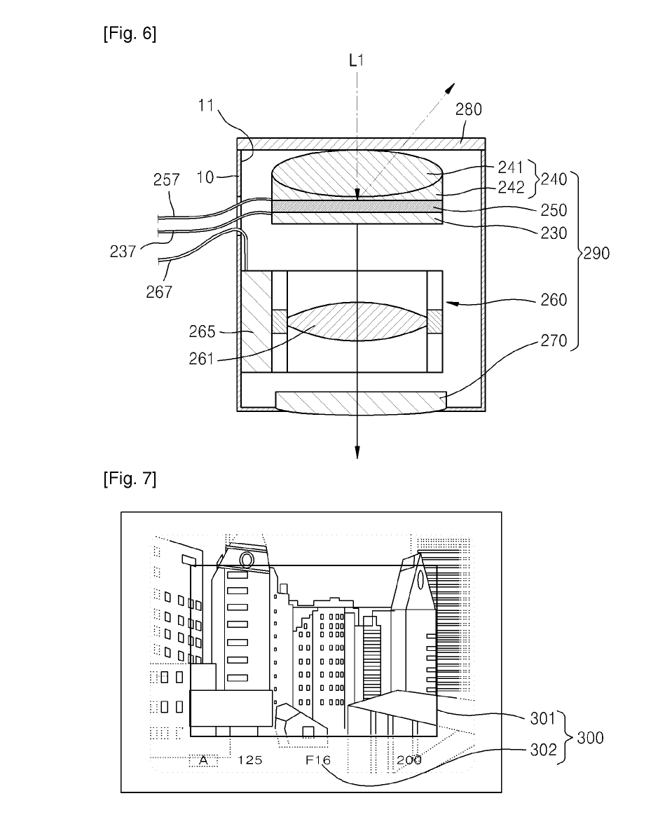

FIG. 5 is a schematic view schematically showing a structure of a view finder device 290 according to another embodiment of the invention, and FIG. 6 is a schematic view showing an operating state of the view finder device 290 of FIGS. 5.

The view finder device 290 shown in FIGS. 5 and 6 includes a main body 10 having a via hole 11, through which light of a subject is transmitted, and a transparent display 230 formed of a transparent material and disposed on the via hole 11 to display images while overlapping the images with the light transmitting through the via hole 11 or to transmit the light.

The view finder device 290 may include a lens 240 including a first lens 241 and a second lens 242 that are disposed on a first optical path L1, and a light blocking unit 250 attached on a surface of the lens 240. The light blocking unit 250 is disposed between the lens 240 and the transparent display 230. The light blocking unit 250 may be a liquid crystal device that is driven on receiving a signal to block or to transmit the light.

In the present embodiment, the light blocking unit 250 is disposed on a rear surface 240r of the lens 240 based on an incident direction of the light of subject; however, embodiments of the invention are not limited thereto. That is, the light blocking unit 250 may be disposed on a front surface 240f of the lens 240 in the direction in which the light of the subject is incident.

The light blocking unit 250 operates to block or to transmit the light when the signal is applied thereto from a control unit (not shown) via a wire 257. FIG. 5 shows a state where the light blocking unit 250 transmits the light, and FIG. 6 shows a state where the light blocking unit 250 blocks the light.

As described in the embodiment with reference to FIGS. 3 and 4, the transparent display 230 is formed of a transparent material to transmit the light, and may display images that overlap with the light transmitted through the transparent display 230 when the signal is applied to the transparent display 230 from the control unit (not shown) via the wire 237.

The view finder device 290 includes a zoom lens unit 260 that is disposed on a rear portion of the transparent display 230 in the direction in which the light is incident. The zoom lens unit 260 includes at least one zoom lens 261 that is moved by a zoom driving unit 265 that is driven when a signal is applied from the control unit (not shown) via a wire 267. When the zoom lens 261 moves along the first optical path L1, an optical magnification of the view finder device 290 may be adjusted.

The view finder device 290 includes an eyepiece 270 that is disposed on a rear portion of the zoom lens unit 260 in the direction in which the light is incident to focus the light transmitted through the via hole 11 and display the image.

A protective panel 280 may be disposed in front of the lens 240 to cover the via hole 11.

As shown in FIG. 5, when the light blocking unit 250 transmits the light, the light transmitted through the via hole 11 sequentially transmits through the lens 240, the transparent display 230, the zoom lens unit 260, and the eyepiece 270. The operating state of the view finder device 290 for providing the user observing the subject with the image of the subject via the eyepiece 270 corresponds to the OVF function.

While the OVF function is executed, the zoom lens unit 260 may be driven to adjust the optical magnification of the image of the subject, which is provided to the user. The zoom lens unit 260 may be driven together with the adjustment of the optical magnification at the lens barrel 110 shown in FIG. 1. Thus, the user may observe the image of the subject that is adjusted according to the optical magnification of the image that will be actually photographed while using the OVF function.

As shown in FIG. 6, when the light blocking unit 250 blocks the light, the light incident from the subject may not transmit through the via hole 11. In this state, the EVF function that displays the live view image acquired by the photographing unit 120 of FIG. 1 on the view finder device 90 may be executed.

FIG. 7 is a diagram showing a view finder image displayed by the view finder device 290 shown in FIG. 5. In FIG. 7, the optical view finder image is displayed when the OVF function is executed by the view finder device 290 according to the embodiments shown in FIGS. 1 through 6.

The optical view finder image is generated through optical elements such as the lens, and thus, has blurred edges. However, information relating to the photographing operation may be displayed while overlapping with the optical view finder image.

The information relating to the photographing may include text information 302 representing information about photographing conditions such as an aperture value or a shutter speed, or a mark 301 representing a focal area in which a focus adjustment with respect to a region to be photographed is made.

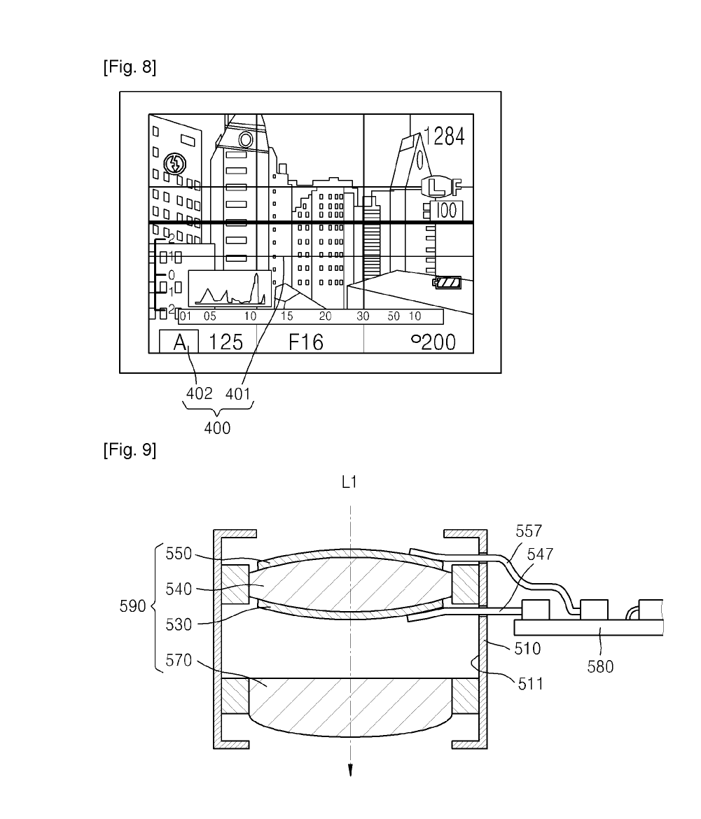

FIG. 8 is a diagram showing a view finder image displayed by the view finder device 290 shown in FIG. 6. In FIG. 8, the electronic view finder image is displayed when the EVF function is executed by the view finder device 290 shown in FIGS. 1 through 6.

The electronic view finder image is generated from an image acquired by the imaging unit shown in FIG. 1 and displayed on the transparent display, and has clear edges. The electronic view finder image may include a grating 401 for guiding the composition for the photographing, a mark representing that an automatic photographing or a manual photographing mode is on, or information about the photographing such as the aperture value or the focusing speed.

FIG. 9 is a schematic view of a view finder device 590 according to another embodiment of the invention.

The view finder device 590 shown in FIG. 9 includes a main body 510 having a via hole 511, through which light from a subject is transmitted, and a transparent display 530 formed of a transparent material and disposed on the via hole 511 for displaying images while overlapping the images with the light transmitting through the via hole 511 or transmitting the light.

The view finder device 590 includes a lens 540 disposed on a first optical path L1, a light blocking unit 550 attached on a surface of the lens 540, and the transparent display 530 attached on the other surface of the lens 540. The lens 540 may be disposed between the light blocking unit 550 and the transparent display 530.

The light blocking unit 550 may be a liquid crystal device that operates on receiving a signal applied from a control unit 580 through a wire 547 to block the light or to transmit the light.

The light blocking unit 550 may be fabricated by forming a transparent panel of a film type by using a transparent material having flexibility, and forming electrode patterns on the transparent panel by using a transparent electric conductive material to display images.

The present embodiment is not limited to the structure of the light blocking unit 550, and the light blocking unit may be fabricated by forming a transparent panel having a curved surface corresponding to the surface of the lens 540 by using a hard transparent material, and forming electrode patterns on the transparent panel to display images. Otherwise, the light blocking unit 550 may be realized by directly forming the electrode patterns on a surface of the lens 540.

The transparent display 530 is formed of a transparent material that transmits the light, and thus, the transparent display 530 may display the images while overlapping the images with the transmitted light on receiving the signal applied from the control unit 580 through the wire 557 or may transmit the light without displaying any image.

The transparent display 530 may be formed as a film type by using the transparent material having flexibility like the light blocking unit 550, and then, may be attached to the other surface of the lens 540. Otherwise, the transparent display 530 may be formed by using a transparent panel having a curved surface corresponding to the surface of the lens 540 or directly forming electrode patterns on the other surface of the lens 540.

The view finder device 590 includes an eyepiece 570 that is disposed on a rear portion of the transparent display 530 in a direction in which the light is incident to focus the light transmitted through the via hole 511 to display images.

According to the view finder device 590 having the above structure, when the light blocking unit 550 transmits the light, the light transmitted through the via hole 511 sequentially transmits through the lens 540, the transparent display 530, and the eyepiece 570 to execute the OVF function to provide the user with the image of the subject. During executing the OVF function, the transparent display 530 may display the image representing various information about the photographing that overlaps with the light transmitted through the via hole 511.

When the light blocking unit 550 is driven by the signal applied from the control unit 580 to block the light incident into the transparent display 530, the EVF function, in which the live view image acquired by the imaging unit 120 shown in FIG. 1 is displayed on the transparent display 530, may be executed.

The device described herein may comprise a processor, a memory for storing program data and executing it, a permanent storage such as a disk drive, a communications port for handling communications with external devices, and user interface devices, including a display, keys, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

1. A view finder device comprising:
a main body including a via hole through which light of a subject is transmitted transmits; and
a transparent display formed of a transparent material that transmits the light and disposed on an optical path of the light that has been transmitted through the via hole in order to: a) transparently transmit the light or b) display images that overlap with the light transmitting through the via hole when a signal is applied to the transparent display.

2. The view finder device of claim 1, further comprising a light blocking unit disposed on the optical path of the light that has been transmitted through the via hole so as to block the light incident into the transparent display or transmit the light to the transparent display.

3. The view finder device of claim 2, further comprising at least one lens disposed on the optical path of the light that has been transmitted through the via hole.

4. The view finder device of claim 3, wherein the lens, the light blocking unit, and the transparent display are sequentially arranged along a proceeding direction of the light that has been transmitted through the via hole.

5. The view finder device of claim 3, wherein the light blocking unit, the lens, and the transparent display are sequentially arranged along a proceeding direction of the light that has been transmitted through the via hole.

6. The view finder device of claim 2, wherein the light blocking unit is a liquid crystal device that transmits the light to the transparent display or blocks the light incident into the transparent display when a signal is applied to the light blocking unit.

7. The view finder device of claim 6, further comprising at least one lens disposed on the optical path of the light that has been transmitted through the via hole, wherein the liquid crystal device is fabricated as a film that is attached to a surface of the lens.

8. The view finder device of claim 1, further comprising a zoom lens unit disposed on the optical path of the light transmitted through the via hole to be movable along the optical path.

9. The view finder device of claim 1, further comprising an eyepiece that is disposed on a rear portion of the transparent display on the optical path of the light that has been transmitted through the via hole, and forms an image with the light.

10. A camera comprising:
a main body including a via hole through which light of a subject is transmitted;
a transparent display formed of a transparent material that transmits the light and disposed on an optical path of the light that has been transmitted through the via hole in order to: a) transparently transmit the light or b) display images that overlap with the light transmitting through the via hole when a signal is applied to the transparent display;
a lens unit disposed apart from the via hole of the main body for receiving the light;
an imaging unit disposed in the main body for converting the light transmitted through the lens unit into a signal representing an image; and
a control unit disposed in the main body and electrically connected to the transparent display and the imaging unit to control the transparent display and the imaging unit.

11. The camera of claim 10, further comprising a light blocking unit disposed on the optical path of the light that has been transmitted through the via hole and controlled by the control unit so as to block the light incident into the transparent display or transmit the light to the transparent display.

12. The camera of claim 11, further comprising at least one lens disposed on the optical path of the light that has been transmitted through the via hole.

13. The camera of claim 12, wherein the light blocking unit is fabricated as a film that is attached to a surface of the lens.

14. The camera of claim 13, wherein the transparent display is fabricated as a film that is attached to the other surface of the lens.

15. The camera of claim 11, wherein the control unit comprises algorithms that selectively execute one of;
an electronic view finder mode, in which the control unit controls the light blocking unit to block the light that has been transmitted through the via hole and controls the transparent display to display images, and
an optical view finder mode, in which the control unit controls the light blocking unit to transmit the light to the transparent display so as to display the subject to be photographed.
